(19) United States
(12) Patent Application Publication
(10) Pub. No.: US 2023/0264927 A1
(43) Pub. Date: Aug. 24, 2023

(54) DYNAMIC LIFT-OFF CONTROL DEVICE, AND CRANE

(71) Applicant: TADANO LTD., Kagawa (JP)

(72) Inventor: Yoshimasa MINAMI, Kagawa (JP)

(73) Assignee: TADANO LTD., Kagawa (JP)

(21) Appl. No.: 18/007,612

(22) PCT Filed: Jun. 3, 2021
(86) PCT No.: PCT/JP2021/021230

§ 371 Date: Dec. 1, 2022

(30) Foreign Application Priority Data
Jun. 3, 2020 (JP) 2020-097025

(51) Int. Cl. B66C 13/06

(52) U.S. Cl. CPC B66C 13/063; B66C 13/066

(57) ABSTRACT

This dynamic lift-off control device is mounted in a crane including a boom and a winch that winds a wire rope, the dynamic lift-off control device controlling dynamic lift-off of a suspended load, wherein the dynamic lift-off device comprises a rotation detection unit that detects the rotation speed of the winch, a pressure detection unit that detects a pressure value of a derricking cylinder that raises/lowers the boom, an estimation unit that estimates the derricking angular velocity of the boom on the basis of the respective detection values from the rotation detection unit and the pressure detection unit, and a control unit that controls the derricking operation of the boom on the basis of the estimated value estimated by the estimation unit and a target derricking angular velocity of the boom that is calculated on the basis of the detection value from the pressure detection unit.

### TECHNICAL FIELD

The present invention relates to a dynamic lift-off control device and a crane for suppressing swing of load when lifting a suspended load from the ground.

### BACKGROUND ART

Conventionally, “swing of load” has been a problem, in which when a crane including a boom lifts a suspended load from the ground, that is, when lifting off the suspended load, the suspended load is swung in a horizontal direction due to an increase in the operating radius by deflection of the boom (see FIG. 1).

For the purpose of preventing swing of load at the time of lift-off, for example, a vertical dynamic lift-off control device described in Patent Literature 1 is configured to detect the rotation speed of the engine by an engine rotation speed sensor and correct the raising operation of the boom to a value corresponding to the engine rotation speed.

### CITATION LIST

### Patent Literature

Patent Literature 1: JP 8-188379 A

### SUMMARY OF THE INVENTION

### Problems to Be Solved by the Invention

The conventional dynamic lift-off control device including Patent Literature 1 has been performing control using a winch actuator and a derricking actuator in combination in order to keep the operating radius constant. Therefore, there has been a problem that it takes time to lift off due to complicated control.

Therefore, an object of the present invention is to provide a dynamic lift-off control device capable of quickly lifting off a suspended load while suppressing swing of load, and a crane including the dynamic lift-off control device.

### Solutions to Problems

One aspect of a dynamic lift-off control device according to the present invention is a dynamic lift-off control device that is mounted in a crane including a boom and a winch that winds a wire rope, and controls dynamic lift-off of a suspended load, the dynamic lift-off control device including: a rotation detection unit that detects a rotation speed of the winch; a pressure detection unit that detects a pressure value of a derricking cylinder for derricking the boom; an estimation unit that estimates a derricking angular velocity of the boom on the basis of a detection value of each of the rotation detection unit and the pressure detection unit; and a control unit that controls derricking operation of the boom on the basis of a target derricking angular velocity of the boom and an estimated value of the estimation unit, the target derricking angular velocity is being calculated on the basis of the detection value of the pressure detection unit.

### Effects of the Invention

According to the present invention, it is possible to provide a dynamic lift-off control device capable of quickly lifting off a suspended load while suppressing swing of load, and a crane including the dynamic lift-off control device.

### BRIEF DESCRIPTION OF DRAWINGS

FIG. 1 is an explanatory view explaining swing of load of a suspended load.

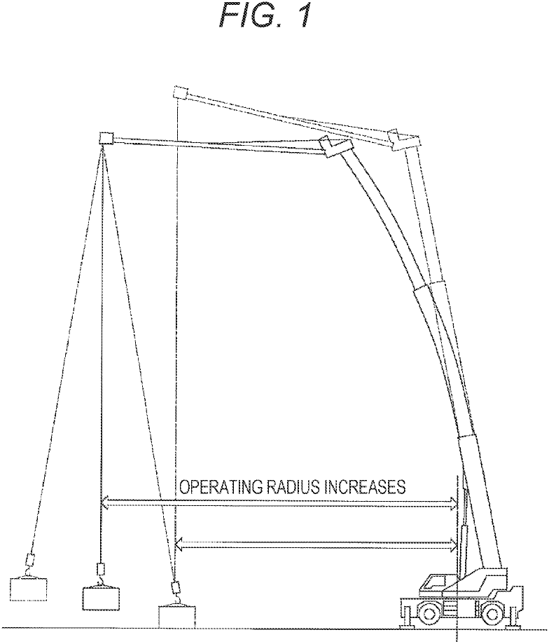

FIG. 2 is a side view of a mobile crane.

FIG. 3 is a block diagram of a dynamic lift-off control device.

FIG. 4 is a block diagram of an entirely of the dynamic lift-off control device.

FIG. 5 is a block diagram of dynamic lift-off control.

FIG. 6 is a block diagram related to estimation of a derricking angular velocity.

FIG. 7 is a flowchart of dynamic lift-off control.

FIG. 8 is a graph explaining a method of dynamic lift-off determination.

FIG. 9 is a graph presenting a relationship between a load and a derricking angle.

FIG. 10 is an explanatory diagram of estimation of a derricking angular velocity.

FIG. 11 is a block diagram of an entirely of a dynamic lift-off control device according to a reference example.

### DESCRIPTION OF EMBODIMENTS

Hereinafter, an example of an embodiment according to the present invention will be described with reference to the drawings. However, the components described in the following embodiment are merely examples, and not intended to limit the technical scope of the present invention only to them.

### Embodiment

In the present embodiment, examples of the mobile crane include a rough terrain crane, an all-terrain crane, and a truck crane. Hereinafter, a rough terrain crane will be described as an example of the work vehicle according to the present embodiment, but the dynamic lift-off control device according to the present invention can also be applied to other mobile cranes. Furthermore, the dynamic lift-off control device according to the present invention can also be applied to a crawler crane or a tower crane.

### Configuration of Mobile Crane

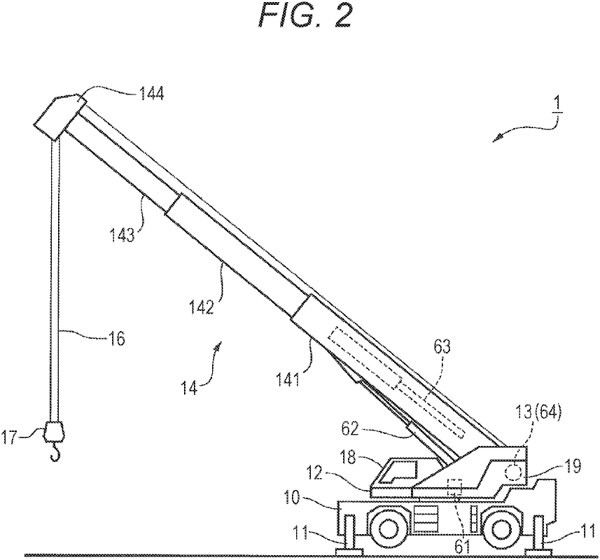

First, the configuration of the mobile crane will be described with reference to the side view of FIG. 2. As illustrated in FIG. 2, a rough terrain crane 1 of the present embodiment includes a vehicle body 10 serving as a main body part of a vehicle having a traveling function, outriggers 11 provided at four corners of the vehicle body 10, a turning table 12 attached to the vehicle body 10 so as to be horizontally turnable, and a boom 14 attached to the rear of the turning table 12.

The outrigger 11 can be slidably overhung/slidably stored outward in the width direction from the vehicle body 10 by extending and retracting a slide cylinder, and can be jack-overhung/jack-stored in the up-down direction from the vehicle body 10 by extending and retracting a jack cylinder.

The turning table 12 includes a pinion gear to which power of a turning motor 61 is transmitted, and when the pinion gear meshes with a circular gear provided on the vehicle body 10, the turning table 12 rotates about a turning shaft. The turning table 12 includes an operator’s seat 18 arranged on a right front side and a counterweight 19 arranged on a rear side.

Furthermore, a winch 13 for winding up and winding down a wire rope 16 is arranged behind the turning table 12. By rotating a winch motor 64 forward or backward, the winch 13 rotates in two directions of a winding direction (winding direction) and a winding down direction (unwinding direction).

The boom 14 is configured in a nested manner by a base end boom 141, an intermediate boom (or intermediate booms) 142, and a tip end boom 143, and extends and retracts by an extension/retraction cylinder 63 arranged therein. A sheave is arranged on a most tip end boom head 144 of the tip end boom 143, and the wire rope 16 is hung on the sheave to suspend a hook 17.

A base end part of the base end boom 141 is rotatably attached to a support shaft installed on the turning table 12. The base end boom 141 can be raised and lowered up and down about the support shaft as a rotation center. A derricking cylinder 62 is stretched between the turning table 12 and the lower surface of the base end boom 141. By extending and retracting the derricking cylinder 62, the entire boom 14 is raised/lowered.

### Configuration of Control System

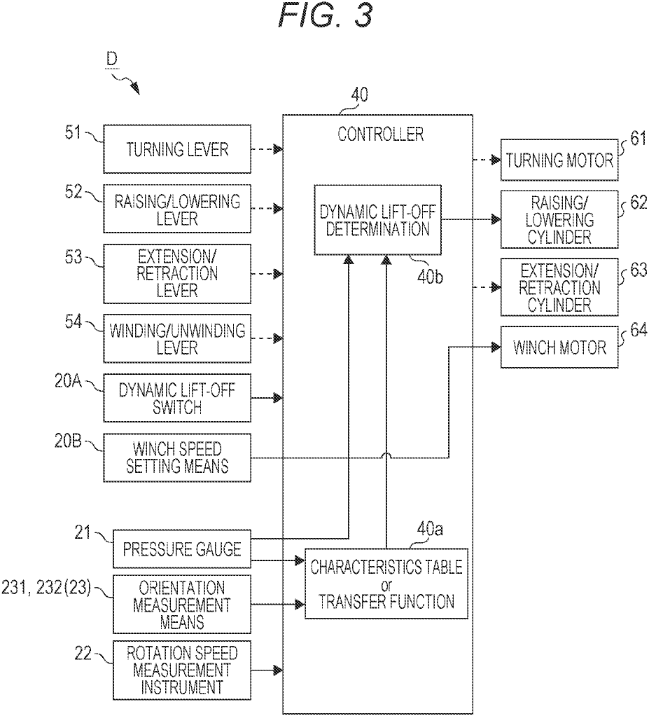

Next, the configuration of a control system of a dynamic lift-off control device D of the present embodiment will be described with reference to the block diagram of FIG. 3. The dynamic lift-off control device D mainly includes a controller 40 as a control unit. The controller 40 is a general-purpose microcomputer including an input port, an output port, and an arithmetic device. Upon receiving an operation signal from operation levers 51 to 54 (turning lever 51, derricking lever 52, extension/retraction lever 53, and winch lever 54), the controller 40 controls actuators 61 to 64 (turning motor 61, derricking cylinder 62, extension/retraction cylinder 63, winch motor 64) via a control valve not illustrated.

Furthermore, the controller 40 is connected with a dynamic lift-off switch 20A for starting and stopping dynamic lift-off control, a winch speed setting means 20B for setting the speed of the winch 13 in the dynamic lift-off control, a pressure gauge 21 as a load measurement means for measuring the load acting on the boom 14, an orientation measurement means 23 for detecting the orientation of the boom 14, and a rotation speed measurement instrument 22 for measuring the rotation speed of the winch 13. Hereinafter, the detection value of the pressure gauge 21 means a pressure value acting on the derricking cylinder 62 and/or a load acting on the boom 14. The load acting on the boom 14 is calculated on the basis of the pressure value acting on the derricking cylinder 62. The dynamic lift-off control by the controller 40 includes control of winding operation of the winch 13 and control of derricking operation of the boom 14.

The dynamic lift-off switch 20A is input equipment for instructing start or stop of the dynamic lift-off control. The dynamic lift-off switch 20A may be configured to be added to a safety device of the rough terrain crane 1, for example. It is preferable that the dynamic lift-off switch 20A is arranged on the operator’s seat 18.

The winch speed setting means 20B is input equipment for setting the speed of the winch 13 in the dynamic lift-off control. The winch speed setting means 20B comes in a type in which an appropriate speed is selected from preset speeds or a type in which the speed is input using a numeric keypad. Furthermore, the winch speed setting means 20B may be configured to be added to a safety device of the rough terrain crane 1, similarly to the dynamic lift-off switch 20A. It is preferable that the winch speed setting means 20B is arranged in the operator’s seat 18. By adjusting the speed of the winch 13 by the winch speed setting means 20B, it is possible to adjust the time required for the dynamic lift-off control.

The pressure gauge 21 corresponds to an example of the pressure detection unit, and the pressure gauge 21, which is measurement equipment for measuring a load acting on the boom 14, is a pressure meter that measures pressure acting on the derricking cylinder 62, for example. In general, it is known that a sampling frequency of a pressure meter is high and accuracy is also high. A pressure signal measured by the pressure meter is transmitted to the controller 40.

The rotation speed measurement instrument 22 corresponds to an example of the rotation detection unit, is installed in the vicinity of the rotation shaft of the winch (drum) 13, and measures the rotation speed (number of rotation) of the winch (drum) 13. As the rotation speed measurement instrument 22, it is possible to use, for example, a sensor such as an electromagnetic pickup sensor, a proximity sensor, an eddy current displacement sensor, or a photoelectric sensor. In general, it is known that these rotation speed measurement instruments 22 have high accuracy. The rotation speed (number of rotation) measured by the rotation speed measurement instrument 22 is transmitted to the controller 40 and used for calculation of the winch winding up speed and the length of the wire rope.

The orientation measurement means 23 is measurement equipment for measuring the orientation of the boom 14, and includes a derricking angle meter 231 that measures the derricking angle of the boom 14 and a derricking angular velocity meter 232 that measures the derricking angular velocity. Specifically, the derricking angle meter 231 is, for example, a potentiometer. The derricking angular velocity meter 232 is, for example, a stroke sensor attached to the derricking cylinder 15. The derricking angle signal measured by the derricking angle meter 231 and the derricking angular velocity signal measured by the derricking angular velocity meter 232 are transmitted to the controller 40.

Here, in the present embodiment, since the derricking angle has a value that can be estimated on the basis of the rotation speed and the pressure, the derricking angular velocity meter 232 is not an essential component. However, as described later, the derricking angular velocity meter 232 becomes necessary when estimating (back calculating) the amount of deviation of the boom head 144 from the position immediately above the suspended load by comparing the estimated value with the actual measured value.

The controller 40 is a control unit that controls the operations of the boom 14 and the winch 13, and, when lifting off the suspended load by winding up the winch 13 when the dynamic lift-off switch 20A is turned on, predicts a change amount of the derricking angle of the boom 14 on the basis of the time change of the load measured by the pressure gauge 21 as the load measurement means, and raises the boom 14 so as to compensate for the predicted change amount.

More specifically speaking, the controller 40 includes, as function units, a selection function unit 40a for selecting a characteristics table or a transfer function stored in advance in a storage unit provided in the controller 40, and a dynamic lift-off determination function unit 40b for stopping the dynamic lift-off control by determining whether or not the dynamic lift-off control has been actually performed.

Upon receiving input of an initial value of the pressure from the pressure gauge 21 as the load measurement means and an initial value of the derricking angle from the derricking angle meter 231 as the orientation measurement means, the selection function unit 40a for characteristics table or transfer function determines the characteristics table or the transfer function to be applied. Here, as the transfer function, a relationship using the linear coefficient a can be applied as follows.

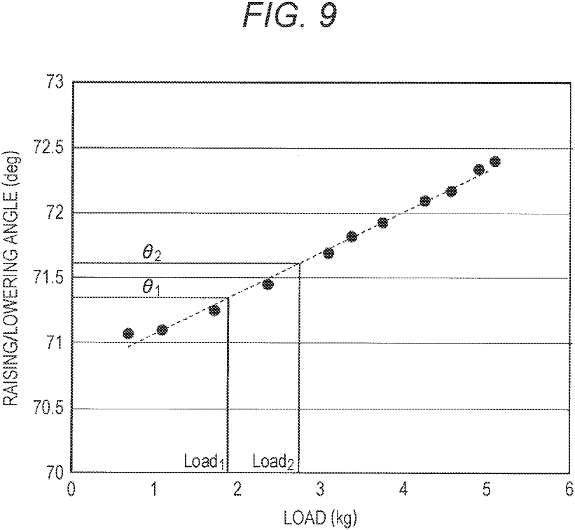

First, as presented in the graph of load-derricking angle of FIG. 9, it is known that the load and the derricking angle (tip ground angle) have a linear relationship when the boom tip end position is adjusted to always come immediately above the suspended load so as not to cause swing of load. Assuming that a load Load₁ changes to Load₂ during lift-off of the ground from time t₁ to time t₂, the relationship between a derricking angle θ and a load Load, the relationship between a derricking angle θ₁ and a load Load₁, and the relationship between a derricking angle θ₂ and a load Load₂ are expressed by the following expressions.

$$\begin{matrix}\text{APPROXIMATE EXPRESSION} \\ {t}_{1} \\ {t}_{2}\end{matrix} \begin{matrix}θ = a ⋅ L o a d + b \\ {θ}_{1} = a ⋅ L o a {d}_{1} + b \\ {θ}_{2} = a ⋅ L o a {d}_{2} + b\end{matrix} \qquad \text{[Math. 1]}$$

The difference between the two expressions is expressed by the following expression by a difference expression.

$$\begin{matrix}{θ}_{2} - {θ}_{1} = a \left(L o a {d}_{2} - L o a {d}_{1}\right) \\ \text{Δ} θ = a ⋅ \text{Δ} L o a d\end{matrix} \qquad \text{[Math. 2]}$$

In order to control the derricking angle, it is necessary to give a derricking angular velocity expressed by the following expression.

$${V}_{L n a} = \frac{\text{Δ} θ}{\left({t}_{2} - {t}_{1}\right)} = a ⋅ \frac{\text{Δ} L o a d}{\text{Δ} t} = a ⋅ {\dot{L}}_{L o a d} \qquad \text{[Math. 3]}$$

Here, a is a constant (linear coefficient).

That is, for the derricking angle control, the time change (differential) of the load is input.

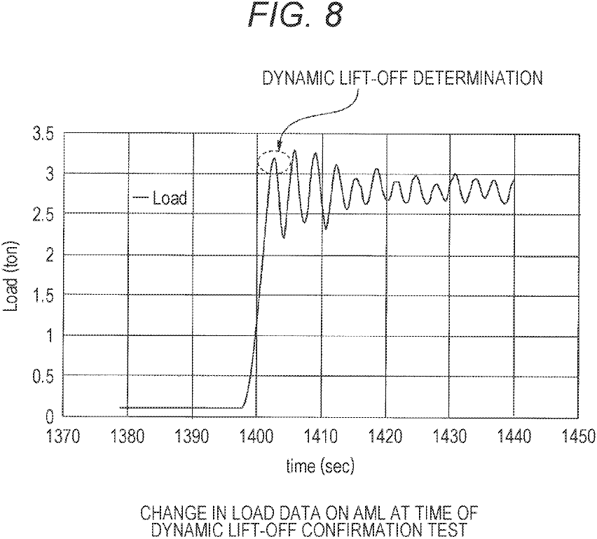

The dynamic lift-off determination function unit 40b monitors time-series data of the value of the load calculated from the pressure signal from the pressure gauge 21 as the load measurement means, and determines the presence or absence of dynamic lift-off. A method of the dynamic lift-off determination will be described later with reference to FIG. 8.

### Overall Block Diagram

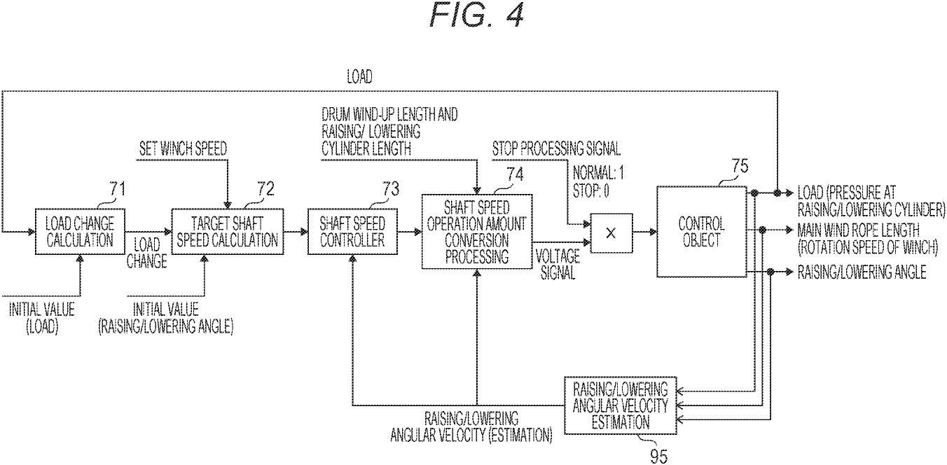

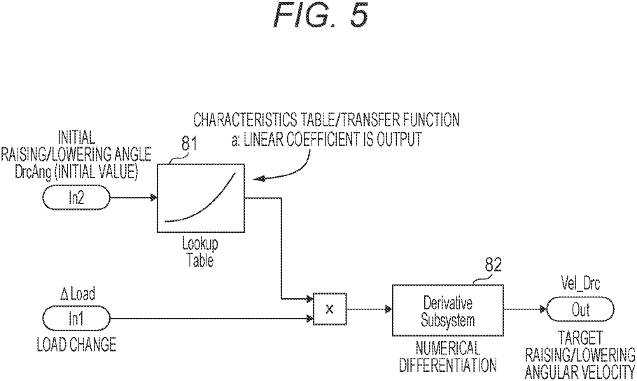

Next, with reference to a block diagram of FIG. 4, an input/output relationship between overall elements including the dynamic lift-off control of the present embodiment will be described in detail. First, a load change calculation unit 71 calculates a load change (that is, a change in the detection value of the pressure gauge 21) on the basis of time-series data of a load measured by the pressure gauge 21 as a load measurement means. The calculated load change is input to a target shaft speed calculation unit 72. The input/output relationship in the target shaft speed calculation unit 72 will be described later with reference to FIG. 5.

The target shaft speed calculation unit 72 calculates the target shaft speed on the basis of the initial value of the derricking angle, the set winch speed, and the input load change. Here, the target shaft speed is a target derricking angular velocity (and, although not essential, the target winch speed). The calculated target shaft speed is input to a shaft speed controller 73. The control of the first half up to this point is processing related to the dynamic lift-off control of the present embodiment.

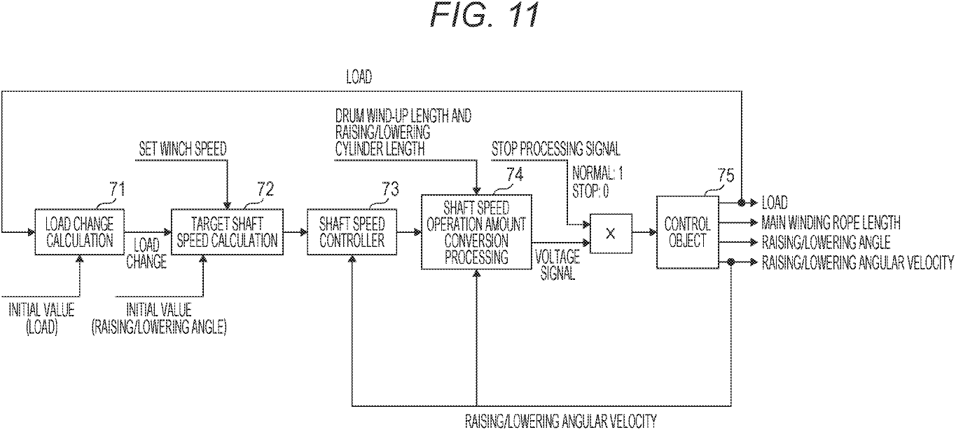

Thereafter, the operation amount is input to a control object 75 via the shaft speed controller 73 and a shaft speed operation amount conversion processing unit 74. The control of the second half is processing related to normal control, and is feedback-controlled on the basis of the derricking angular velocity estimated by a derricking angular velocity estimation unit 95. FIG. 11 is a block diagram of a dynamic lift-off control device according to the reference example. In the case of the dynamic lift-off control device illustrated in FIG. 11, the control object 75 is feedback-controlled on the basis of the measured derricking angular velocity. In the case of the dynamic lift-off control device according to such a reference example, if the resolution of the device that measures the derricking angular velocity is low, accuracy of the control may decrease.

### Block Diagram of Dynamic Lift-Off Control

Next, an input/output relationship of elements in the target shaft speed calculation unit 72 of dynamic lift-off control in particular will be described with reference to the block diagram of FIG. 5. First, the initial value of the derricking angle is input to a selection function unit 81 (40a) of the characteristics table/transfer function. The selection function unit 81 selects the most appropriate constant (linear coefficient) a using a characteristics table (lookup table) or a transfer function.

Then, a numerical differentiation unit 82 performs numerical differentiation (time-related differentiation) of the load change, and calculates the target derricking angular velocity by multiplying the result of the numerical differentiation by the constant a. That is, the target derricking angular velocity is calculated by executing the calculation of (Expression 3) described above. Thus, the control of the target derricking angular velocity is feedforward-controlled using the characteristics table (or transfer function).

### Block Diagram Related to Estimation of Derricking Angular Velocity

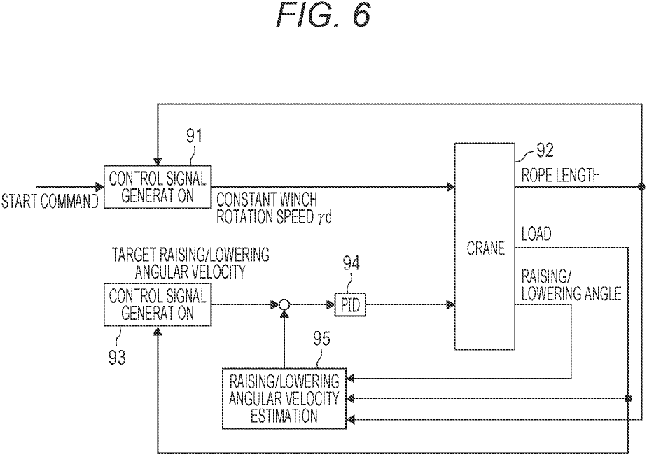

Next, with reference to the block diagram of FIG. 6, an input/output relationship when estimating the derricking angular velocity on the basis of the initial derricking angle of the boom 14, the load (pressure) acting on the boom 14, and the rotation speed of the winch 13 will be described. First, by a start command, a first control signal generation unit 91 instructs a crane 92 (winch motor 64) that is a control object so as to maintain the speed of the winch 13 at a constant number of rotation γd. The winch speed control is feedback-controlled on the basis of a measured rope length. As described later, the derricking angular velocity estimation unit 95 estimates the derricking angular velocity on the basis of the initial derricking angle, the load (pressure acting on the boom 14), and the rope length (rotation speed of the winch).

Thereafter, a second control signal generation unit 93 (corresponding to the target shaft speed calculation unit 72) calculates a correction target derricking angular velocity on the basis of a difference between the target derricking angular velocity calculated by the above-described procedure and a derricking angular velocity (described later) estimated by the derricking angular velocity estimation unit 95, and instructs a PID control unit 94 for the correction target derricking angular velocity. The PID control unit 94 generates a derricking angular velocity control signal by PID control. This derricking angular velocity control is feedback-controlled on the basis of the measured load and the estimated derricking angular velocity (see FIGS. 4 and 5).

Then, on the basis of the initial derricking angle, the load (pressure), and the rope length (rotation speed of the winch), the derricking angular velocity estimation unit 95 estimates the derricking angular velocity. That is, in the present embodiment, the derricking angular velocity can be predicted in real time using an existing sensor without using the derricking angular velocity meter 232. Hereinafter, an estimation method of derricking angular velocity will be described.

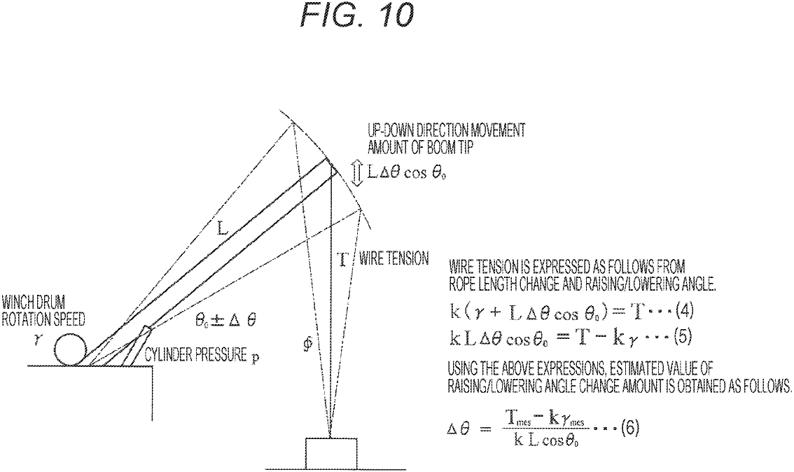

First, a geometric relationship of an up-down direction movement amount of the boom tip end (boom head 144) will be described also with reference to the explanatory view of FIG. 10. As illustrated in FIG. 10, a tension T of the wire rope is expressed as Expression (4) illustrated in FIG. 10 from the rope length change and the derricking angle change amount. That is, when the spring coefficient of the wire rope is k, the tension T of the wire rope can be expressed as T = k • (extension amount) . Since this “extension amount” is the sum of the wind up amount (number of rotation or rotation speed) of the winch 13 and the up-down direction movement amount of the boom tip end (boom head 144), Expression (4) is obtained.

When the left side of Expression (4) is expanded and the term of the rotation speed γ is transposed to the right side, Expression (5) illustrated in FIG. 10 is obtained. Then, a derricking angle change amount Δθ (estimated value) is expressed as Expression (6) illustrated in FIG. 10. According to Expression (6), if the spring coefficient k of the wire rope 16 is known, the derricking angle change amount Δθ (estimated value) can be calculated on the basis of the measurement value of the tension T of the wire rope (obtained by calculation from the pressure value) and the measurement value of the rotation speed γ. Here, L is a boom length, and θ₀ is an initial value (initial derricking angle) of the derricking angle (as the boom length L and the initial derricking angle θ₀, initial values can be used in a range of a minute derricking angle). Then, by differentiating both sides of Expression (6), the estimated value of the derricking angular velocity can be calculated on the basis of the change rate of the tension T of the wire rope and the change rate of the rotation speed (number of rotation).

### Flowchart

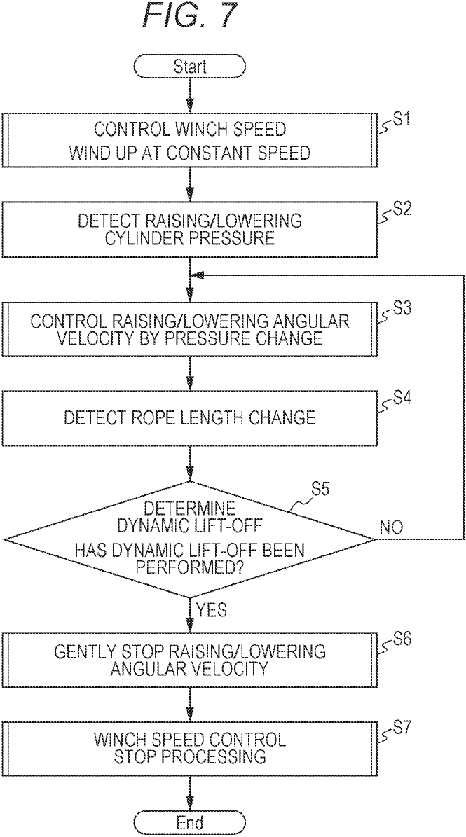

Next, the overall flow of the dynamic lift-off control of the present embodiment will be described with reference to the flowchart of FIG. 7.

First, the operator presses the dynamic lift-off switch 20A to start the dynamic lift-off control (START). At this time, the target speed of the winch 13 is set via the winch speed setting means 20B before the start in advance or after the start of the dynamic lift-off control. Then, the controller 40 starts winch control at the target speed (step S1). This target speed is a constant speed.

Next, at the same time when the winch 13 is wound up, the pressure gauge 21 as a load measurement means starts suspended load measurement (derricking cylinder pressure detection), and a load value (pressure value) is input to the controller 40 (step S2).

Next, upon receiving input of the initial value of the load value (pressure value) and the initial value of the derricking angle from the derricking angle meter 231 as an orientation measurement means, the selection function unit 40a determines the characteristics table or the transfer function to be applied (step S3). Next, the controller 40 calculates the target derricking angular velocity on the basis of the characteristics table or transfer function to be applied and the load change (step S3). That is, the derricking angular velocity control is performed by feedforward-control. In step S3, an estimated value of the derricking angular velocity estimated by the derricking angular velocity estimation unit 95 is fed back. Then, a control signal for controlling the derricking operation of the boom 14 is generated on the basis of the target derricking angular velocity calculated by the controller 40 and the derricking angular velocity estimated by the derricking angular velocity estimation unit 95 of the controller 40. On the basis of the generated control signal, the controller 40 controls the operation of the derricking cylinder 62, which is a control object.

Next, a time-series change in the rope length is detected for use in the subsequent dynamic lift-off determination (step S4). Specifically, the measurement result of the rotation speed measured by the rotation speed measurement instrument 22 and the orientation (derricking angle, derricking angular velocity, and boom length) measured by the orientation measurement means 23 is input to the controller 40 to calculate the rope length, and the time-series change is monitored.

Then, the controller 40 determines the presence or absence of dynamic lift-off control on the basis of the time-series data of the measured load and/or rope length (step S5) . The determination method will be described later. As a result of the determination, if the lift-off has not been performed (NO in step S5), the process returns to step S3 to repeat the feedforward-control based on the load (steps S3 to S5).

As a result of the determination, if the dynamic lift-off has been performed (YES in step S5), the dynamic lift-off control is gently stopped (step S6). That is, derricking drive by the derricking cylinder 62 is stopped while gradually decreasing the speed (step S6), and rotational drive of the winch 13 by the winch motor 64 is stopped while gradually decreasing the speed (step S7). In this way, the dynamic lift-off control ends (END).

### Dynamic Lift-Off Determination 1

Next, a method of the dynamic lift-off determination of the present embodiment will be described with reference to the graph of FIG. 8. In the present embodiment, the controller 40 monitors time-series data of the measured load in the middle of winding up the winch 13 in the dynamic lift-off control, and can determine that the dynamic lift-off is performed by capturing the first local maximal value of this time-series data.

More specifically, as presented in FIG. 8, in general, time series of load data transitions so as to be overshooting at the next moment after dynamic lift-off control, undershooting, and then continuously vibrating. Therefore, it is possible to determine that the dynamic lift-off has been performed by capturing the time of the peak of the first peak of vibration, that is, the first local maximal value. Actually, however, it is considered that at the time when the first local maximal value is recorded, which is the time when it is determined that the dynamic lift-off has been performed, the load is slightly overshooting upon receiving of inertial force.

### Dynamic Lift-Off Determination 2

Apart from such a method, the controller 40 of the present embodiment can also be configured to determine dynamic lift-off control on the basis of a time change in the measured load and a time change in the measured rope length when dynamic lift-off of the suspended load is performed by winding up the winch 13 in the dynamic lift-off control.

Specifically, when performing lift-off of the suspended load by winding up the winch 13, the controller 40 as the control unit sets, as an initial rope length, the rope length at the time when the measured load starts to change, and determines that the dynamic lift-off control is performed when the rope length becomes shorter than a threshold set from the initial rope length.

Alternatively, when the winch 13 is wound up and the suspended load is lifted off, the controller 40 as the control unit sets, as an initial winding speed, the time change in the rope length at the time when the measured load starts to change, and determines that the dynamic lift-off control is performed when the winding speed, which is the time change in the rope length, becomes faster than a threshold set from the initial winding speed.

### Effects

Next, effects achieved by the dynamic lift-off control device D of the present embodiment will be listed and described.

(1) As described above, the dynamic lift-off control device D of the present embodiment includes the boom 14, the derricking cylinder 62, the pressure gauge 21, the winch 13, the rotation speed measurement instrument 22, and the controller 40 configured to estimate the derricking angular velocity of the boom on the basis of the rotation speed and the pressure. Such a configuration makes the dynamic lift-off control device capable of quickly lifting off a suspended load while suppressing swing of load by accurately estimating the derricking angular velocity.

That is, in the dynamic lift-off control device D of the present embodiment, focusing on the linear relationship between the load and the derricking angle-compensation amount, the suspended load can be quickly lifted off by performing feedforward control on the basis of only on the time change of the load value without performing complicated feedback control as in the conventional art.

Then, even if the derricking angular velocity meter (232) is not particularly mounted, the dynamic lift-off control device D of the present embodiment can estimate the derricking angular velocity in real time with high accuracy on the basis of other high-accuracy measurement values (derricking angle and rotation speed). Furthermore, even when the resolution performance and the response performance of the derricking angle meter 231 are poor, the derricking angular velocity can be obtained with high accuracy.

(2) It is preferable that when estimating the derricking angle (derricking angular velocity) of the boom 14, the controller 40 statistically estimates an elastic coefficient (spring coefficient) k of the wire rope 16 on the basis of a plurality of actual measured values. That is, it is of course possible to actually measure and set the spring coefficient k at the time of exiting from the factory, but it is also possible to continue to correct the spring coefficient k on the basis of actual measurement data at the time of actual use. At this time, a measurement value by another measurement instrument such as the derricking angle meter 231 can be used as a reference.

(3) It is preferable that the controller 40 further includes a derricking angle measurement instrument that measures the derricking angular velocity of the boom 14, and the controller 40 estimates the amount of deviation of the boom head 144 from immediately above the suspended load on the basis of a difference between the measured derricking angular velocity and the estimated derricking angular velocity. That is, in Expression (3), where the derricking angle and the derricking angular velocity are estimated on the assumption that the suspended load is pulled immediately above, if the derricking angle and the derricking angular velocity are actually measured by another sensor, the position of the boom head 144 can be back calculated on the basis of the amount of deviation by comparing the estimated value and the actually measured value. By operating the boom 14 so as to reduce the amount of deviation, the boom head 144 can be positioned immediately above the suspended load. That is, since the change amount of the derricking angle due to deflection of the boom 14 can be estimated with a load change, the boom head 144 can be maintained immediately above the suspended load by adjusting the position of the boom head 144 so as to correct the change amount.

(4) It is preferable to further include the orientation measurement means 23 for measuring the orientation of the boom 14, and the controller 40 selects a corresponding characteristics table or transfer function on the basis of the initial value of the measured orientation of the boom 14 and the initial value of the measured pressure, and obtains the change amount of the derricking angle of the boom 14 from the time change of the measured pressure using the characteristics table or the transfer function.

With this configuration, at the start of dynamic lift-off control, the winch 13 is wound up at a constant speed, and the derricking angle control amount is calculated from the characteristics table (or the transfer function) in accordance with the load change to perform feedforward control, whereby the dynamic lift-off can be promptly performed without swing of load. In addition, reduction of the number of parameters to be adjusted makes it possible to quickly and easily perform adjustment at the time of shipment.

Here, since the derricking angular velocity cannot be directly measured by an existing sensor, the measured angle is differentiated or an estimated value is used. However, when the angle is differentiated, noise easily enters, and therefore the accuracy is lowered. Therefore, the present embodiment proposes a method for estimating the derricking angular velocity on the basis of the derricking angle (initial value of the derricking angle), the load, and the change in rotation speed of the winch.

Furthermore, the necessary derricking angle correction amount can be calculated by being able to estimate the derricking angle change in this manner. By performing control in accordance with the calculated derricking angle correction amount, it is easy to align the position of the boom head 144 immediately above the suspended load.

(5) Furthermore, it is preferable that the controller 40 winds up the winch 13 at a constant speed when winding up the winch 13 and lifting off the suspended load. With this configuration, the influence of disturbance such as inertial force is suppressed, and the response (measured load value) is stabilized, whereby dynamic lift-off determination can be made easy.

(6) It is preferable that the controller 40 adjusts the time required for dynamic lift-off by adjusting the speed of the winch 13 when winding up the winch 13 to lift off the suspended load. With this configuration, it is possible to work safely and efficiently by selecting an appropriate speed of the winch 13 according to the weight of the suspended load and the environmental conditions.

(7) Furthermore, the controller 40 of the present embodiment monitors time-series data of the measured load when winding up the winch 13 to lift off the suspended load, and determines that the dynamic lift-off is performed by capturing the first local maximal value of the time-series data. By performing control on the basis only on the load in this manner, it is possible to easily and quickly determine dynamic lift-off.

(8) By including any of the above-described dynamic lift-off control devices D, the rough terrain crane 1, which is the mobile crane of the present embodiment, becomes capable of quickly lifting off the suspended load while suppressing swing of load.

Although the embodiment of the present invention has been described in detail with reference to the drawings, the specific configuration is not limited to this embodiment, and a design change to an extent not departing from the gist of the present invention is included in the present invention.

For example, although not particularly described in the embodiment, the dynamic lift-off control device D of the present invention can be applied to both a case of performing dynamic lift-off using a main winch as the winch 13 and a case of performing dynamic lift-off using a sub winch.

The entire disclosure of the description, drawings, and abstract included in Japanese Patent Application No. 2020-97025 filed on Jun. 3, 2020 is incorporated herein by reference.

### INDUSTRIAL APPLICABILITY

The dynamic lift-off control device according to the present invention can be applied not only to a mobile crane but also to various cranes.

Reference Signs List

| D | dynamic lift-off control device |
|---|---|
| a | linear coefficient |
| 1 | rough terrain crane |
| 10 | vehicle body |
| 12 | turn table |
| 13 | winch |
| 14 | boom |
| 16 | wire rope |
| 17 | hook |
| 20A | dynamic lift-off switch |
| 20B | winch speed setting means |
| 21 | pressure gauge (load measurement means) |
| 22 | rotation speed measurement instrument |
| 23 | orientation detection means |
| 231 | derricking angle meter |
| 232 | derricking angular velocity meter |
| 40 | controller |
| 40 a | selection function unit |
| 40 b | dynamic lift-off determination function unit |
| 51 | turning lever |
| 52 | derricking lever |
| 53 | extension/retraction lever |
| 54 | winch lever |
| 61 | turning motor |
| 62 | derricking cylinder |
| 63 | extension/retraction cylinder |
| 64 | winch motor |
| 91 | first control signal generation unit |
| 93 | second control signal generation unit |
| 92 | crane (control object) |
| 94 | PID control unit |
| 95 | derricking angular velocity estimation unit |

1. A dynamic lift-off control device that is mounted in a crane including a boom and a winch that winds a wire rope, and controls dynamic lift-off of a suspended load, the dynamic lift-off control device comprising:
a rotation detection unit that detects a rotation speed of the winch;
a pressure detection unit that detects a pressure value of a derricking cylinder for derricking the boom;
an estimation unit that estimates a derricking angular velocity of the boom on a basis of a detection value of each of the rotation detection unit and the pressure detection unit; and
a control unit that controls derricking operation of the boom on a basis of a target derricking angular velocity of the boom and an estimated value of the estimation unit, the target derricking angular velocity is being calculated on a basis of the detection value of the pressure detection unit.

2. The dynamic lift-off control device according to claim 1 further comprising:
a storage unit that stores in advance a table or an expression for calculating the target derricking angular velocity on a basis of the detection value of the pressure detection unit, wherein
the control unit
selects the table or the expression on a basis of an initial value of a derricking angle of the boom and an initial value of the pressure value, and
calculates the target derricking angular velocity on a basis of the table or the expression having been selected.

3. The dynamic lift-off control device according to claim 1, wherein the control unit controls the winch to wind up the winch at a constant speed in the dynamic lift-off control.

4. The dynamic lift-off control device according to claim 1, wherein the control unit adjusts time required for dynamic lift-off by adjusting a winding speed of the winch in the dynamic lift-off control.

5. The dynamic lift-off control device according to claim 1, wherein upon detecting a first local maximal value in the detection value of the pressure detection unit, the control unit determines that dynamic lift-off is completed and stops the derricking operation.

6. A crane comprising the dynamic lift-off control device according to claim 1.
